(19) United States
(12) Patent Application Publication
(10) Pub. No.: US 2003/0004048 A1
(43) Pub. Date: Jan. 2, 2003

(54) Sheet folding up and rolling machine

(75) Inventor: Chwan-Jon Wang, Taichung (TW)

Correspondence Address: BROWDY AND NEIMARK, P.L.L.C., 624 NINTH STREET, NW, SUITE 300, WASHINGTON, DC, 20001-5303, US

(73) Assignee: Paraton International Co., LTD., Taipei (TW)

(21) Appl. No.: 10/180,498

(22) Filed: Jun. 27, 2002

(30) Foreign Application Priority Data
Jun. 27, 2001 (TW) 90210744

(51) Int. Cl. B31F 1/08

(52) U.S. Cl. 493/428

(57) ABSTRACT

A sheet folding up and rolling machine comprises a frame member, which has an input tunnel at a side thereof and an output tunnel at the other side thereof. A feeding cylinder assembly has at a feeding cylinder and two pressing wheels pivoted in the frame member behind the input tunnel for drawing a sheet into the frame member. Five folding cylinders are pivoted in the frame member behind the feeding cylinder assembly for turning the path of the sheet. Two guiding plates are secured in the frame member corresponding to the feeding cylinder assembly and the folding cylinders respectively for guiding the sheet. Two limiting members are secured in the frame member, each of which has an opening facing to the folding cylinders respectively for the sheet can run into the limiting members to be folded up. A pair of rolling cylinders are pivoted in the frame behind the folding cylinders for rolling the folded sheet. A coupler assembly has a coupler belt for driving the feeding cylinder assembly, the folding cylinders and the rolling cylinders to turn, and a driving unit disposed at the frame member for driving the coupler belt to turn.

### FIELD OF THE INVENTION

The present invention related to a sheet processing apparatus, and more particularly to a sheet folding up and rolling machine, which can fold up and roll sheets.

### BACKGROUND OF THE INVENTION

In office works, operator tears, cuts, rolls and folds up sheets and puts the folded sheets into envelopes to mail them, or just simply folds up the sheet to mail them. This only can process a small amount of mails. If there are a large amount of mails to process, it will take too much time.

Some workplaces have to process a large amount of documents to mail, such as power bills, water bills and traffic tickets etc. At this time, they just simply fold up the sheets to hide the information inside and leave the address and the name of the receiver at outside. Then, operator seals the folded sheets by stickers or seals it by paste. Thus, the sheets are ready to mail.

I found the sealing procedure is totally operated by labors in the prior art that takes much time and takes a higher cost.

### SUMMARY OF THE INVENTION

The primary objective of the present invention is to provide a sheet folding up and rolling machine, which can fold up and roll sheets in a step.

The secondary objective of the present invention is to provide a sheet folding up and rolling machine, which can reduce labor cost.

According to the objective of the present invention, a sheet folding up and rolling machine comprises a frame member, which has an input tunnel at a side thereof and an output tunnel at the other side thereof. A feeding cylinder assembly has at least one feeding cylinder pivoted in the frame member behind the input tunnel. At least five folding cylinders are pivoted in the frame member behind the feeding cylinder assembly. At least two guiding plates are secured in the frame member corresponding to the feeding cylinder assembly and the folding cylinders respectively. At least two limiting members are secured in the frame member, each of which has an opening facing to the folding cylinders respectively. A pair of rolling cylinders are pivoted in the frame behind the folding cylinders. A coupler assembly has a coupler belt for driving the feeding cylinder assembly, the folding cylinders and the rolling cylinders to turn, and a driving unit disposed at the frame member for driving the coupler belt to turn.

### BRIEF DESCRIPTION OF THE DRAWINGS

FIG. 1 is a perspective view of a prefer embodiment of the present invention.

FIG. 2 is a perspective view in part of the prefer embodiment of the present invention, showing the feeding cylinder assembly, the folding cylinders, the guiding plates and the rolling cylinders.

FIG. 3 is a lateral view of the prefer embodiment of the present invention, where the side frames are removed.

FIG. 4 is a lateral view of the prefer embodiment of the present invention, showing the relationships among the motor, the coupler belt and the wheels.

FIG. 5 to FIG. 10 are perspective views of the prefer embodiment of the present invention in operating, showing how a sheet folded up and rolled.

FIG. 11 is a perspective view, showing a printer working with the prefer embodiment of the present invention.

FIG. 12 shows the sheets being folded up by the present invention in different types.

### DETAIL DESCRIPTION OF THE INVENTION

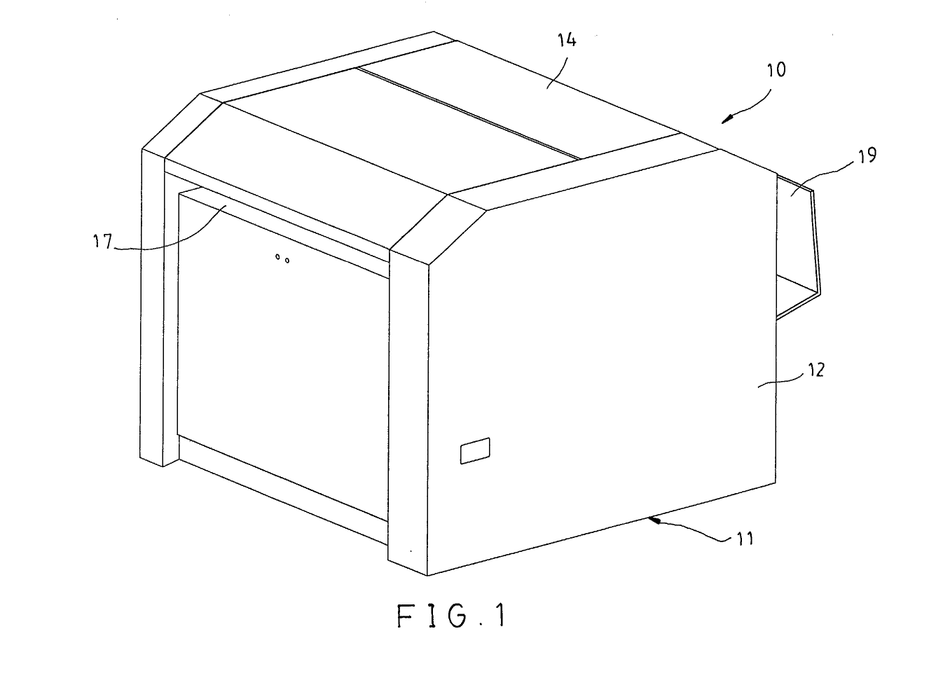

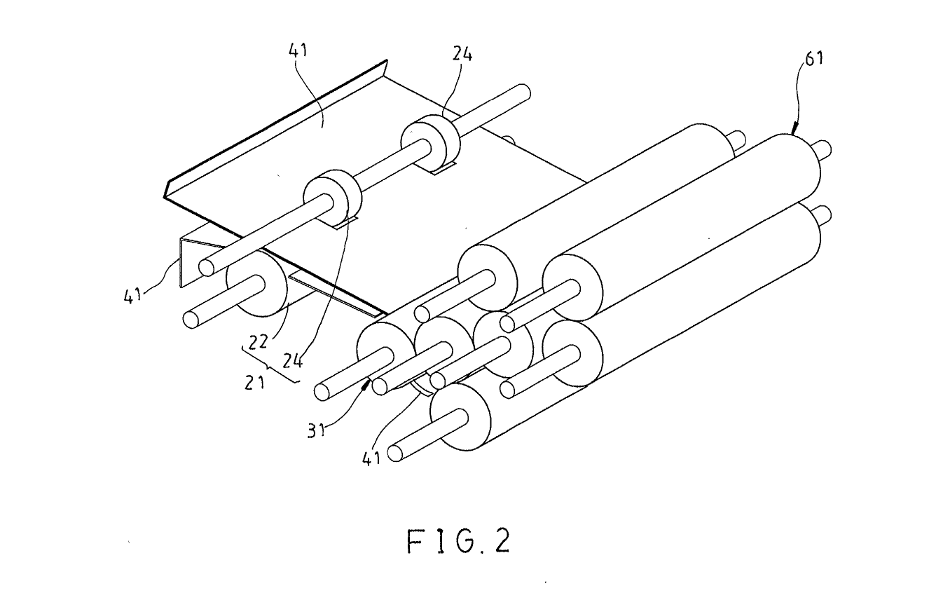

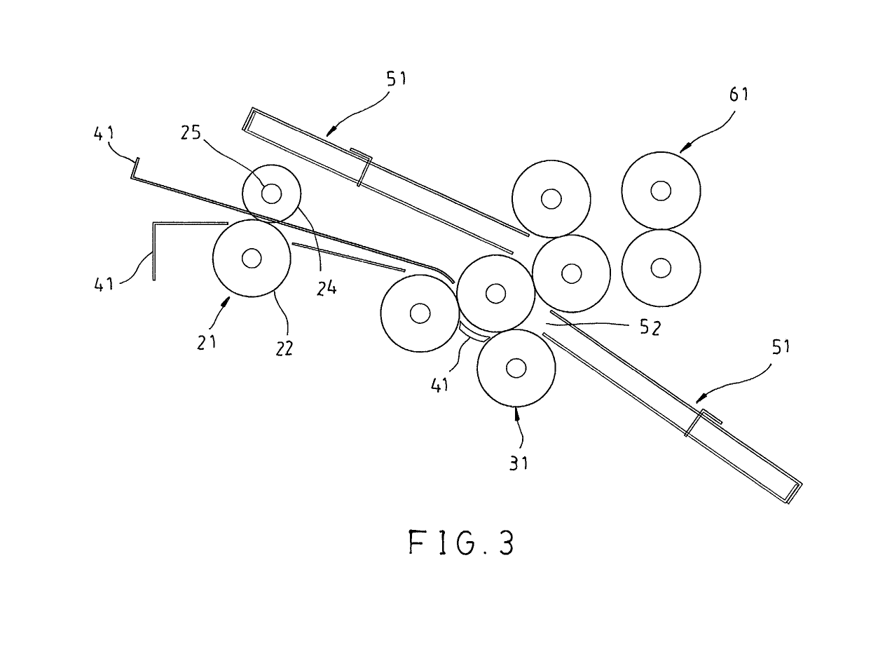

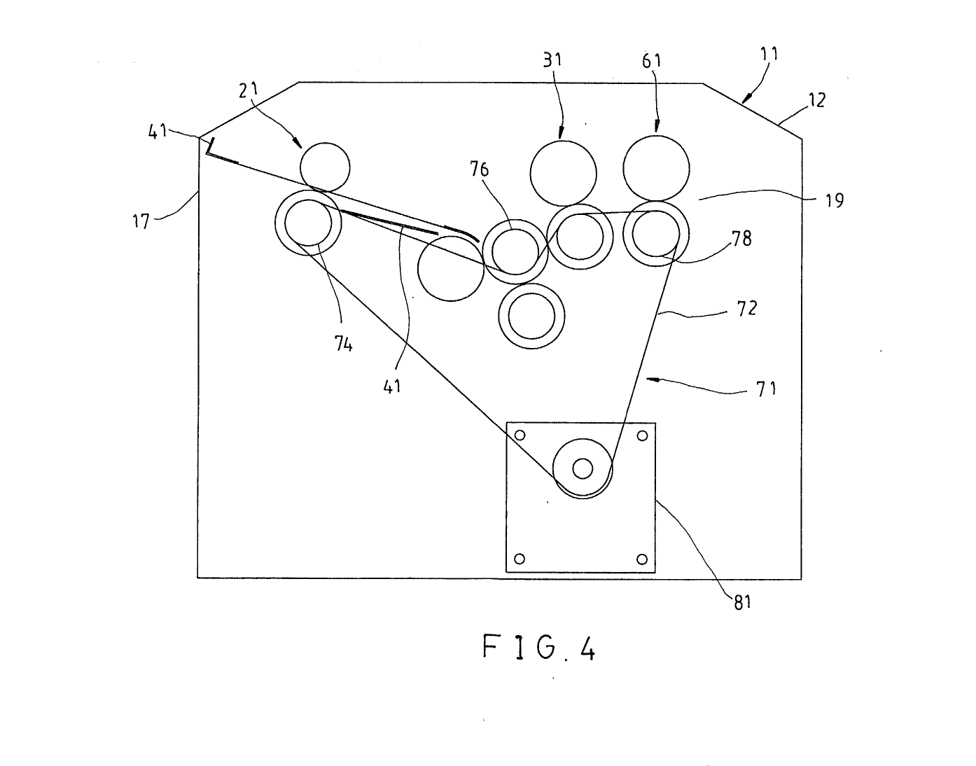

Please refer to FIGS. from FIG. 1 to FIG. 4, a sheet folding up and rolling machine 10 of the prefer embodiment of the present invention mainly comprises a frame member 11, a feeding cylinder assembly 21, at least five folding cylinders 31, a plurality of guiding plates 41, at least two limiting members 51, a pair of rolling cylinders 61, a coupler assembly 71 and a driving unit 81.

The frame member 11 has two side frames 12 and a plurality of shells 14 connecting the side frames 12. The frame member 11 has an input tunnel 17 at front side thereof and an output tunnel 19 at back side thereof.

The feeding cylinder assembly 21 has at least one feeding cylinder 22 and two pressing wheels 24. The feeding cylinder 22 is pivoted at between the side frames 12 of the frame member 11 closing to the input tunnel 17 of the frame member 11. The pressing wheels 24 are secured on a shaft and the shaft has the opposite ends pivoted to the side frames 12 of the frame member 11 respectively for free rotating. The pressing wheels 24 are against the feeding cylinder 22 for a sheet can be drived to run through. The feeding cylinder 22 has an end extending out of the side frame 12.

The folding cylinders 31 are installed in the frame member 11 behind the feeding cylinder assembly 21 having opposite ends thereof pivoted to the side frames 12 respectively for free rotating. There is one folding cylinder 312 having an end extending out of the side frame 12.

The guiding plates 41 are disposed in the frame member 11 having the opposite ends thereof secured to the side frames 12 respectively. One guiding plate 41 positions in between the feeding cylinder 22 and the pressing wheels 24, the other one of which positions below the feeding cylinder 312 of the feeding cylinder assembly 21.

The limiting members 51 are disposed in the frame member 11 having the opposite ends thereof secured to the side frames 12 respectively. The limiting members are disposed at opposite sides of the folding cylinders 31 respectively, each of which has an opening 52 facing the folding cylinders 31. The limiting members 51 are to guiding the sheet passing through the feeding cylinder assembly 21 to be folded up. The limiting members 51 are as same as the conventional elements, so I do not describe the detail here.

The rolling cylinders 61, which are made of metal, are disposed in the frame member 11 having the opposite ends thereof pivoted to the side frames 12 respectively for free rotating. The rolling cylinders 61 position behind the last cylinder of the folding cylinder assembly 31 and close to the output tunnel 19 of the frame member 11. One rolling cylinder 61 has an end extending out of the side frame 12.

The coupler assembly 71 constructs from a coupler belt 72, a first wheel 74, a second wheel 76 and a third wheel 78. The first wheel 74 is secured on the feeding cylinder 22 at the end of extending out of the side frame 12, the second wheel 76 is secured at the extending end of the folding cylinder 312 and the third wheel 78 is secured at the extending end of the rolling cylinder 61. Thus, the coupler belt 72 can drive the feeding cylinder assembly 21, the folding cylinder assembly 31 and the rolling cylinders 61 to turn.

The driving unit 81, which is a motor in this prefer embodiment, is secured at the frame member 11 and coupled with the coupler belt 72 of the coupler assembly 71 for driving the coupler belt 72 to turn.

Before operating, we pre-prepare a sheet 99, which has glue capsule particles on the surface (not shown). The glue capsule particles will be broken by means of exerting a pressure on them and they will release glue received therein to spread the glue on the surface of the sheet 99.

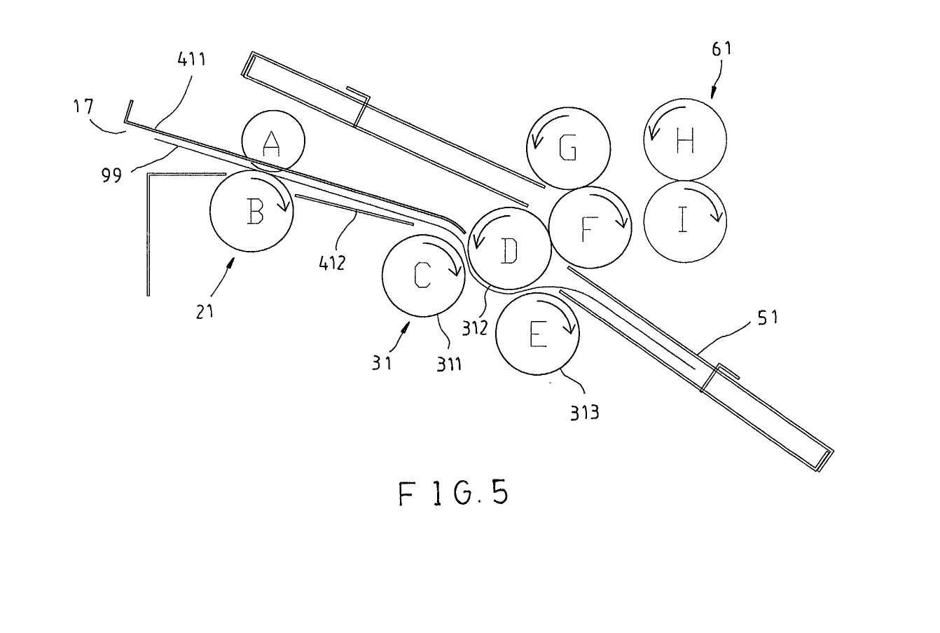

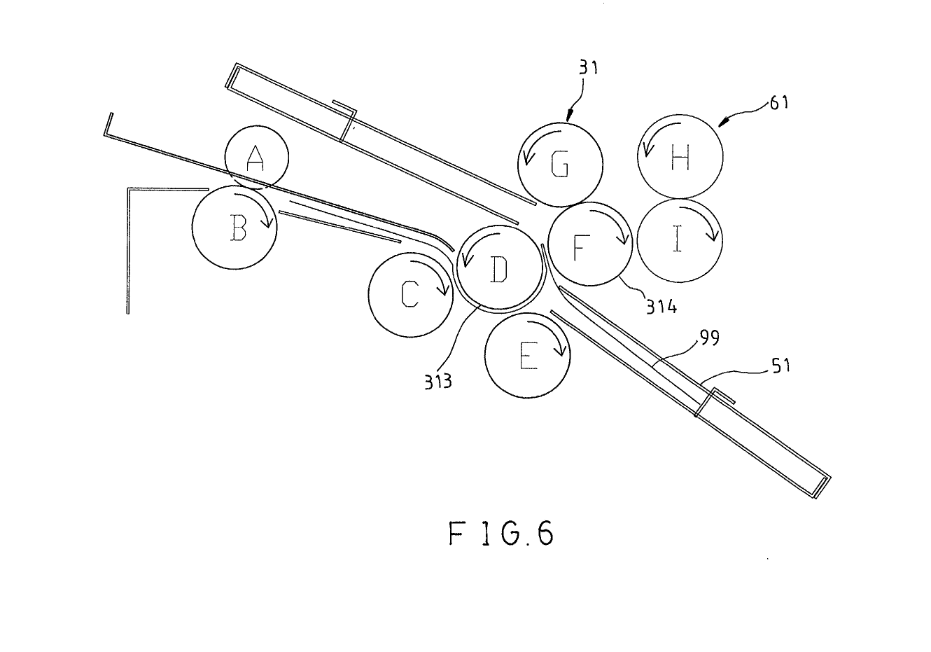

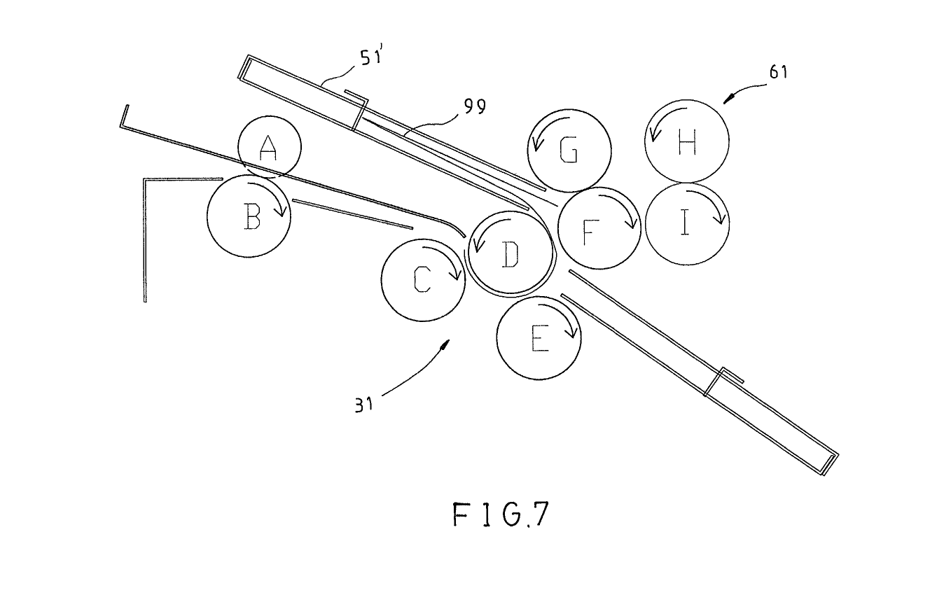

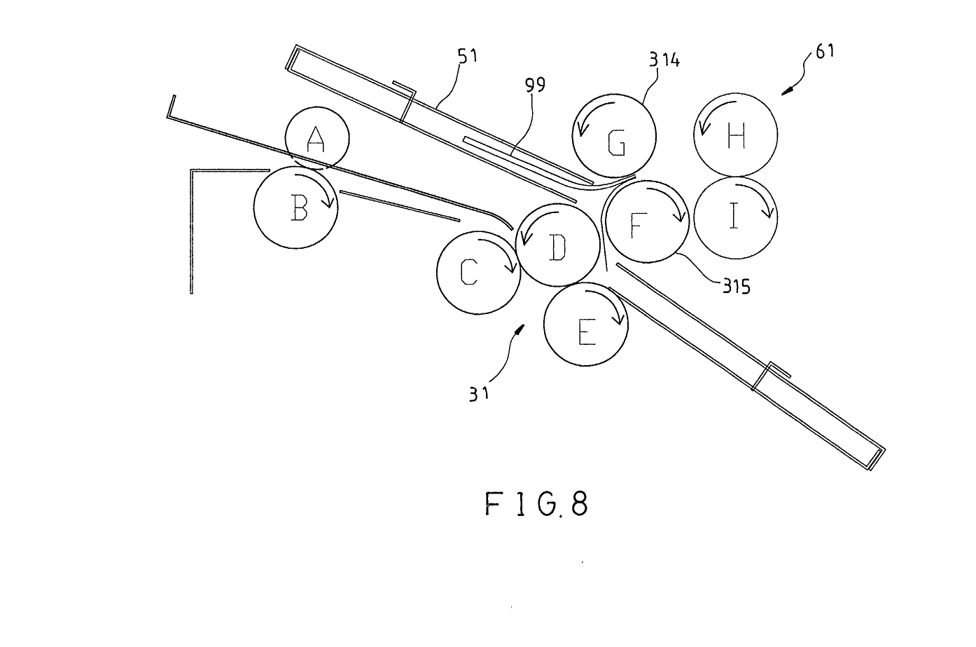

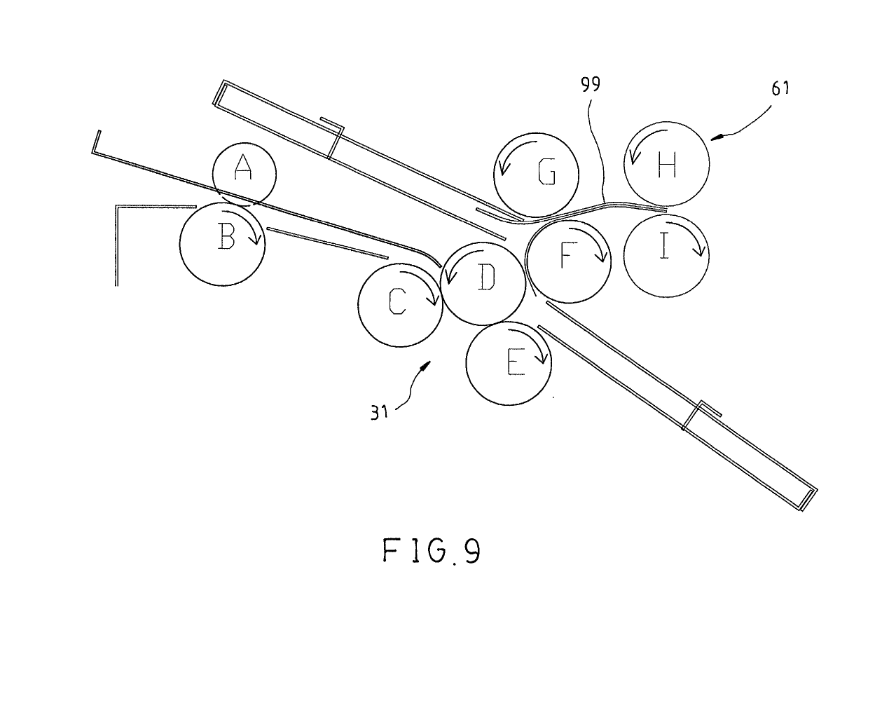

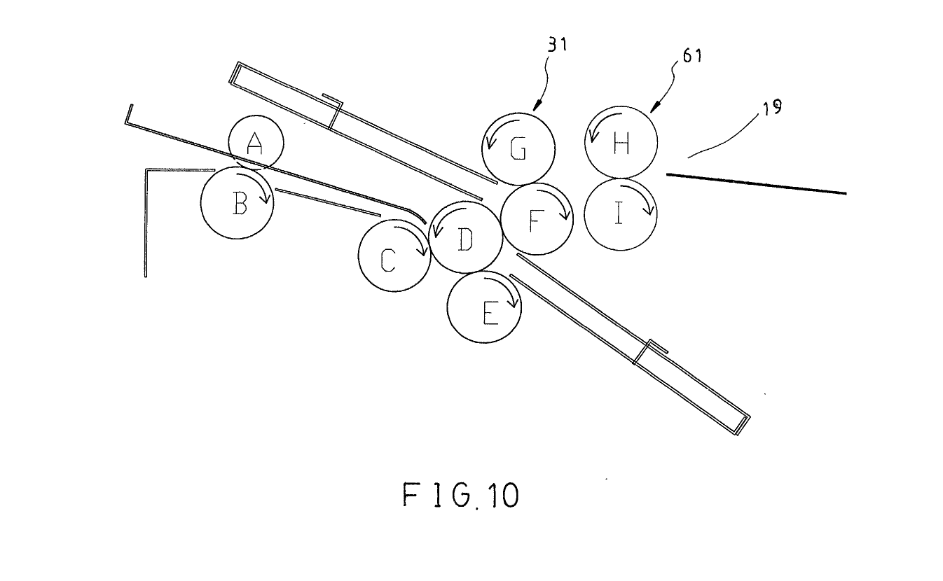

Please refer to FIGS. from FIG. 5 to FIG. 10, operator puts the sheet into the input tunnel 17, the feeding cylinder assembly 21 will draw the sheet 99 in and drive it running to the folding cylinders 21 automatically. The sheet 99 will be driven by the folding cylinders 311, 312 and 313 first and runs into the first limiting member 51 and as shown in FIG. 5. Then, please refer to FIG. 6, the sheet 99 will be stopped in the limiting member 51 and will be bent at midsection. The bent section of the sheet 99 will be drawn by the folding cylinders 313 and 314 continually and runs into the second limiting member 51′ to be stopped therein as shown in FIG. 7. Now, the sheet 99 will be bent again, as shown in FIG. 8, and will be drawn by the folding cylinders 314 and 315. After that, please refer to FIG. 9, the folded sheet 99 will driven to pass through the rolling cylinders 61. At this time, the glue capsule particles on the sheet 99 will be broken to make the folded sheet stuck at predetermined portion. Finally, a folded and sealed sheet 99 will be sent out of the frame member 11 via the output tunnel 19 as shown in FIG. 10.

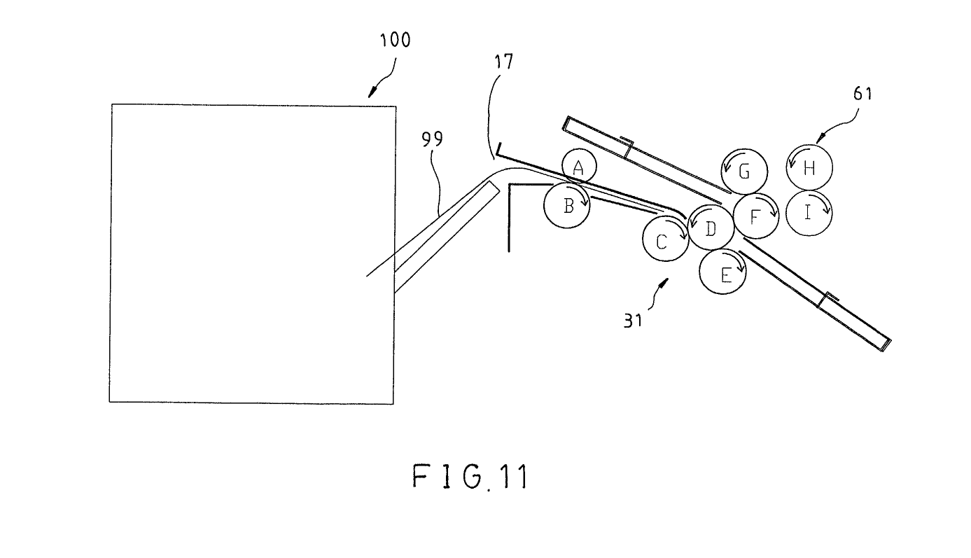

FIG. 11 shows the sheet folding up and rolling machine 10 of the present invention works with a printer 100. The printer 100 sends the sheets 99 to the input tunnel 17 of the sheet folding up and rolling machine 10 directly for the sheets 99 can be printed, folded and sealed in one step. That meets the workplaces of where need to process the sheets to mail in a large amounts within a short time.

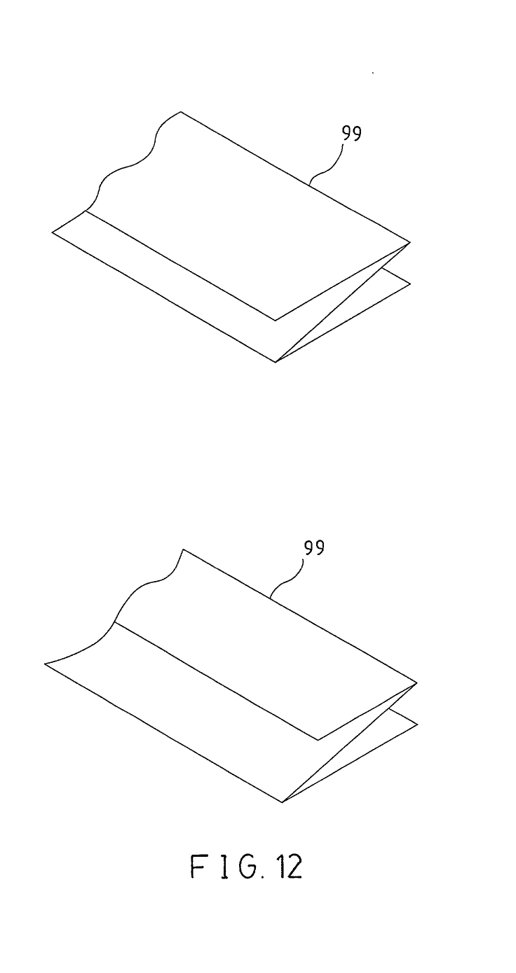

Furthermore, operator can adjust the depths of the limiting members 51 to change where the sheets 99 to be bent. Please refer to FIG. 12, if the depth of the first limiting member 51 is as same as the depth of the second limiting member 51′, the sheet will be folded up like the upper sheet 99 shown in FIG. 12. But, if the depth of the first limiting member 51 is smaller than the depth of the second limiting member 51′, the sheet will be folded up like the bottom sheet 99 shown in FIG. 12.

The advantages of the present invention are:

1. The sheet folding up and rolling machine of the present invention has a high performance of folding up and sealing the sheet to be a mail in one step.

2. There is no labor work needed in the sheet process. It saves the cost a lot.

3. The rolling cylinders will break glue capsule particles on the sheets and make them sealed. So, there is no need to provide an extra apparatus in the machine to seal the sheets. The size of the machine of the present invention will be smaller than the conventional machine.

What is claimed is:

1. A sheet folding up and rolling machine, comprising:
a frame member having an input tunnel at a side thereof and an output tunnel at the other side thereof;
a feeding cylinder assembly having at least one feeding cylinder pivoted in said frame member behind said input tunnel for driving a sheet;
at least five folding cylinders pivoted in said frame member behind said feeding cylinder assembly for the sheet that passes through said feeding cylinder assembly can pass through said folding cylinders continually;
at least two guiding plates secured in said frame member corresponding to said feeding cylinder assembly and said folding cylinders respectively for guiding the sheet passing through said feeding cylinder assembly and said folding cylinders;
at least two limiting members secured in said frame member, each of which has an opening facing to said folding cylinders respectively, for the sheet can run into said limiting members and to be bent;
a pair of rolling cylinders, which are made of metal, pivoted in said frame behind said folding cylinders for rolling the sheet;
a coupler assembly having a first wheel secured on said feeding cylinder, a second wheel secured on said folding cylinder, a third wheel secured on said rolling cylinder and a coupler belt mounted around said first wheel, said second wheel and said third wheel for driving said feeding cylinder assembly, said folding cylinders and said rolling cylinders to turn, and
a driving unit disposed at said frame member for driving said coupler belt to turn.

2. The sheet folding up and rolling machine as defined in claim 1, wherein said feeding cylinder assembly further has two pressing cylinders pivoted in said frame member and being against said feeding cylinder.

3. The sheet folding up and rolling machine as defined in claim 1, wherein said driving unit is a motor.

4. The sheet folding up and rolling machine as defined in claim 1, wherein said frame member has two side frames and a plurality of shells connecting said side frames.

5. The sheet folding up and rolling machine as defined in claim 4, wherein said first, second and third wheels of said coupler ass embly are positioned at exterior side of one of said side frames.
